(19) United States
(12) Patent Application Publication
(10) Pub. No.: US 2006/0023306 A1
(43) Pub. Date: Feb. 2, 2006

(54) Rear projection screen

(75) Inventor: Hideki Miyata, Tokyo-to (JP)

Correspondence Address: OLIFF & BERRIDGE, PLC, P.O. BOX 19928, ALEXANDRIA, VA, 22320, US

(73) Assignee: DAI NIPPON PRINTING CO., LTD, Tokyo-to (JP)

(21) Appl. No.: 11/191,061

(22) Filed: Jul. 28, 2005

(30) Foreign Application Priority Data
Jul. 30, 2004 (JP) 2004-223224

(51) Int. Cl. G03B 21/56

(52) U.S. Cl. 359/460

(57) ABSTRACT

Proposed herein is a rear projection screen for use with a single-light-source projector, having no loss of imaging light and scarcely causing glaring. The rear projection screen is a combination of two or more optical members in the form of sheets or windable films, capable of transmitting, diffusing, or condensing light. In this rear projection screen, the light diffusivity in the vertical direction of a light-diffusing element (a light-diffusing layer and/or an embossed surface) that is situated on the viewer side of the viewer-side outermost optical element of one, or two or more optical elements that comprise lenses or prisms for diffusing light in the horizontal and/or vertical direction is higher at the center portion of the screen than at the upper and/or lower edge portion of the screen.

### BACKGROUND OF THE INVENTION

1. Field of the Invention

The present invention relates to a rear projection screen for use in a projection system of rear projection type such as a rear projection television, and, more particularly, to a rear projection screen that is used in a projection system of rear projection type in which a single-light-source projector using an LCD, a DMD, or the like is employed and that is excellent in uniformity of screen brightness.

2. Background Art

A rear projection screen 71 as is shown in FIG. 9, composed of a Fresnel lens sheet 72 that is positioned on the light source side, a light source (not shown in the figure) being located on the far-side of the figure, and a lenticular lens sheet 73 that is positioned on the viewer side of the Fresnel lens sheet 72, is now usually used in a projection system of rear projection type in which a CRT is employed as a projector (light source). The lenticular lens sheet 73 is a double lenticular lens sheet having lenticular lenses on the both sides, the light-entering surface side and the light-emerging surface side. Light-absorbing parts 76 are provided on the non-light-emerging areas, through which no light passes, of the light-emerging surface of the lenticular lens sheet 73. Recently, a rear projection screen as shown in FIG. 9, in which a transparent or colored protective sheet with a smooth surface (not shown in the figure) is placed on the viewer side of the lenticular lens sheet 73 in the rear projection screen 71 has come to be the mainstream.

On the other hand, unlike CRTs, single-light-source projectors using LCDs, DMDs, or the like have, in recent years, come to be used more often in projection systems of rear projection type. A rear projection screen that may be used along with such a single-light-source projector is one obtained by laminating a lenticular lens sheet in the form of a film, having, on the light-entering surface side, lenses such as lenticular lenses for controlling the diffusion of light in the horizontal direction, and, on the light-emerging surface side, light-absorbing parts, to a base containing a light-diffusing agent, with the light-emerging surface of the former facing to the surface of the latter.

In such rear projection screens for use with single-light-source projectors using LCDs, DMDs, or the like, optical elements such as lenses or prisms are required to have fine pitches so that moiré does not occur between the optical elements and pixels, and the pitches of Fresnel lenses, lenticular lenses, etc, are now made less than 200 μm. In such rear projection screens containing fine-pitched optical elements, very high positioning accuracy is required to precisely provide light-absorbing parts on the non-light-emerging areas (areas through which no light passes) of a lenticular lens sheet. To meet this requirement, there has so far been proposed such a manner that light-absorbing parts are formed on the light-emerging surface of a lenticular lens sheet (film) photolithographically by making use of the light-converging properties of lenticular lenses (see Japanese Laid-Open Patent Publication No. 120102/1997, for example).

On the other hand, a problem with projection televisions for which single-light-source projectors using LCDs, DMDs, or the like are employed is that glaring, called scintillation, occurs on screens.

A possible technique for reducing scintillation is to impart enhanced diffusivity to rear projection screens. However, if the diffusivity of a rear projection screen is simply enhanced, the screen gain decreases, and the image projected on the screen thus entirely becomes dim.

In addition, in the case where the above-described lenticular lens sheet (a lenticular lens sheet having, on the light-emerging surface side, light-absorbing parts that are formed by a photolithographic technique or the like) is used, if an increased amount of a diffusing material, which is placed on the light source side with respect to the light-absorbing parts, is incorporated in the rear projection screen in order to impart enhanced diffusivity to the screen, imaging light is diffused also in the horizontal direction due to the light-diffusing effect of the diffusing material and is therefore absorbed by the light-absorbing parts, which leads to further decrease in screen brightness.

### SUMMARY OF THE INVENTION

The present invention has been accomplished in the light of the aforementioned drawbacks in the related art. An object of the present invention is therefore to provide a rear projection screen for use with a single-light-source projector, having almost no loss of imaging light and scarcely causing glaring.

The present invention provides, as a first aspect of the invention, a rear projection screen comprising two or more optical members for transmitting, diffusing, or condensing light, in the form of sheets or windable films extending along the screen plane, the two or more optical members including one, or two or more optical elements that comprise lenses or prisms for diffusing light in the horizontal and/or vertical direction and a light-diffusing element that is situated on the viewer side of the viewer-side outermost optical element of the one, or two or more optical elements, the light diffusivity in the vertical direction of the light-diffusing element being higher at the center portion of the screen than at the upper and/or lower edge portion of the screen.

The present invention provides, as a second aspect of the invention, a rear projection screen comprising two or more optical members for transmitting, diffusing, or condensing light, in the form of sheets or windable films extending along the screen plane, the two or more optical members including a light-absorbing element for absorbing light and a light-diffusing element that is situated on the viewer side of the light-absorbing element, the light diffusivity in the vertical direction of the light-diffusing element being higher at the center portion of the screen than at the upper and/or lower edge portion of the screen.

In the above-described first and second aspects of the present invention, the half angle of diffusion at the center portion of the screen is preferably 1.04 to 1.90 times that at the upper and/or lower edge portion of the screen.

Further, in the above-described first and second aspects of the present invention, the light-diffusing element preferably comprises a light-diffusing layer that contains light-diffusing particles. In this case, it is preferable that the thickness of the light-diffusing layer be small at the upper and/or lower edge portion of the screen and great at the center portion of the screen. It is also preferable that the thickness, at the center portion of the screen, of the light-diffusing layer be 1.02 to 1.83 times the thickness, at the upper and/or lower edge portion of the screen, of the light-diffusing layer.

In the above-described first and second aspects of the invention, it is preferable that the light-diffusing element comprises two or more light-diffusing layers containing light-diffusing particles, and that the thickness of at least one of the two or more light-diffusing layers be small at the upper and/or lower edge portion of the screen and great at the center portion of the screen. In this case, it is preferable that the thickness of at least one, at the center portion of the screen, of the two or more light-diffusing layers be 1.02 to 1.83 times the thickness, at the upper and/or lower edge portion of the screen, of the at least one light-diffusing layer. Further, it is preferable that the two or more light-diffusing layers have the properties of diffusing light that are different from each other. Furthermore, it is preferable that the light-diffusing element contains a non-light-diffusing layer provided between the two or more light-diffusing layers.

In the above-described first and second aspects of the invention, the light-diffusing element is preferably for isotropically diffusing light, and not only the light-diffusing layer containing light-diffusing particles but also an embossed surface or a combination of the light-diffusing layer and an embossed surface may constitute this element.

According to the first aspect of the present invention, the light-diffusing element that is situated on the viewer side of the viewer-side outermost optical element of the one, or two or more optical elements that comprise lenses or prisms for diffusing light in the horizontal and/or vertical direction are so made that the light diffusivity in the vertical direction of the light-diffusing element is higher at the center portion of the screen than at the upper and/or lower edge portion of the screen. Therefore, it becomes possible to obtain a rear projection screen that undergoes almost no decrease in luminance that is caused by the loss of imaging light and scarcely causes glaring, without decreasing the resolution at the upper and lower edge portions of the screen. Now, stronger scintillation is observed on a part of the screen on which the illuminance of light from a light source is higher, so that the strongest scintillation is observed usually at the center portion of the screen, which is at the shortest distance from a light source. Therefore, by enhancing the diffusivity at the center portion of the screen at which the strongest scintillation is observed, it is possible to reduce glaring on the screen while maintaining screen brightness high, without decreasing the gain of the other part of the screen.

In general, in a rear projection screen of this type, the screen resolution is determined by the pitch of lenses or prisms of an optical element, having the function of diffusing light in the horizontal or vertical direction. In the case where a light-diffusing element is present on the light source side of such an optical element, imaging light is diffused before it enters the optical element, so that the imaging light enters even those parts of the optical element on which the imaging light should not be incident (adjacent lenses or prisms, for example). For this reason, when the light diffusivity in the vertical direction is, for reducing scintillation, made higher at the center portion of the screen than at the upper and/or lower edge portion of the screen, by placing a light-diffusing element on the light source side of the optical element comprising lenses or prisms, the resolution at the center portion of the screen becomes lower than that at the upper and/or lower edge portion of the screen.

On the contrary, according to the first aspect of the invention, a light-diffusing element whose light diffusivity in the vertical direction is higher at the center portion of the screen than at the upper and/or lower edge portion of the screen is provided on the viewer side of the viewer-side outermost optical element of the one, or two or more optical elements that comprise lenses or prisms for diffusing light in the horizontal and/or vertical direction. Therefore, the above-described reduction in resolution does not occur, and it becomes possible to obtain a rear projection screen that is reduced in scintillation and scarcely causes glaring.

Further, according to the second aspect of the invention, the light-diffusing element that is situated on the viewer side of the light-absorbing element is so made that the light diffusivity in the vertical direction of the light-diffusing element is higher at the center portion of the screen than at the upper and/or lower edge portion of the screen. It is therefore not necessary to concern about the reduction in luminance due to loss of imaging light at the light-absorbing parts that is caused by the increase in the degree to which imaging light is diffused, and it thus becomes possible to obtain a rear projection screen that scarcely causes glaring.

According to the first and the second aspects of the invention, since the diffusivity is high at the center portion of the screen, flaws in the center portion of a Fresnel lens that tend to be created in the course of production of the lens by cutting become inconspicuous.

### BRIEF DESCRIPTION OF THE DRAWINGS

In the drawings,

FIG. 1 is a partially cutaway view in perspective of a rear projection screen according to an embodiment of the present invention;

FIG. 2 is a diagrammatic sectional view showing the rear projection screen shown in FIG. 1;

FIG. 3 is a diagrammatic sectional view showing a modification of the rear projection screen shown in FIG. 1;

FIG. 4 is a diagrammatic sectional view showing another modification of the rear projection screen shown in FIG. 1;

FIG. 5 is a diagrammatic sectional view showing a further modification of the rear projection screen shown in FIG. 1;

FIG. 6 is a partially cutaway view in perspective of a rear projection screen according to another embodiment of the present invention;

FIG. 7 is a partially cutaway view in perspective showing a modification of the rear projection screen shown in FIG. 6;

FIG. 8 is a partially cutaway view in perspective showing another modification of the rear projection screen shown in FIG. 6; and

FIG. 9 is a partially cutaway view in perspective of a conventional rear projection screen.

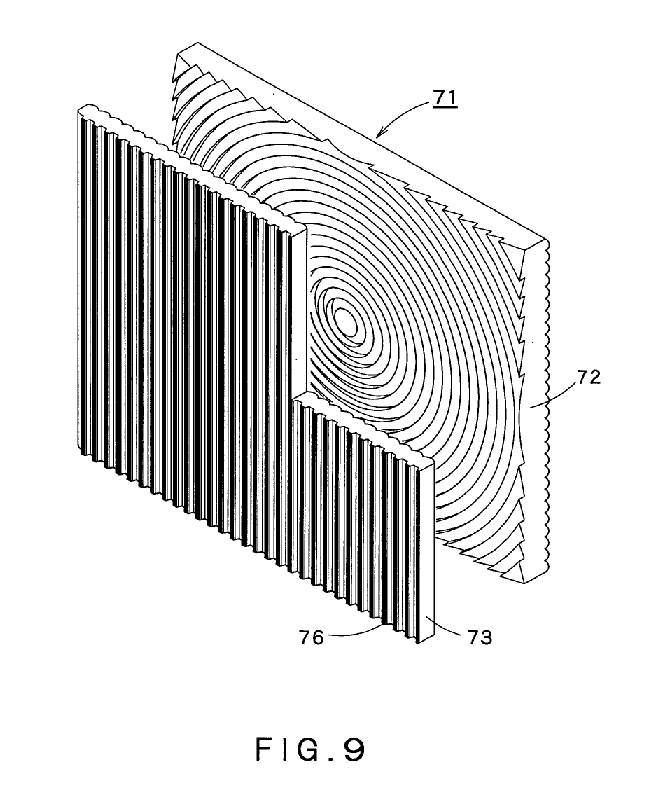

### DETAILED DESCRIPTION OF PREFERRED EMBODIMENTS

Embodiments of the present invention will be described hereinafter with reference to the accompanying drawings. Optical members depicted in the drawings are exaggerated in terms of dimensions, structure, and so on.

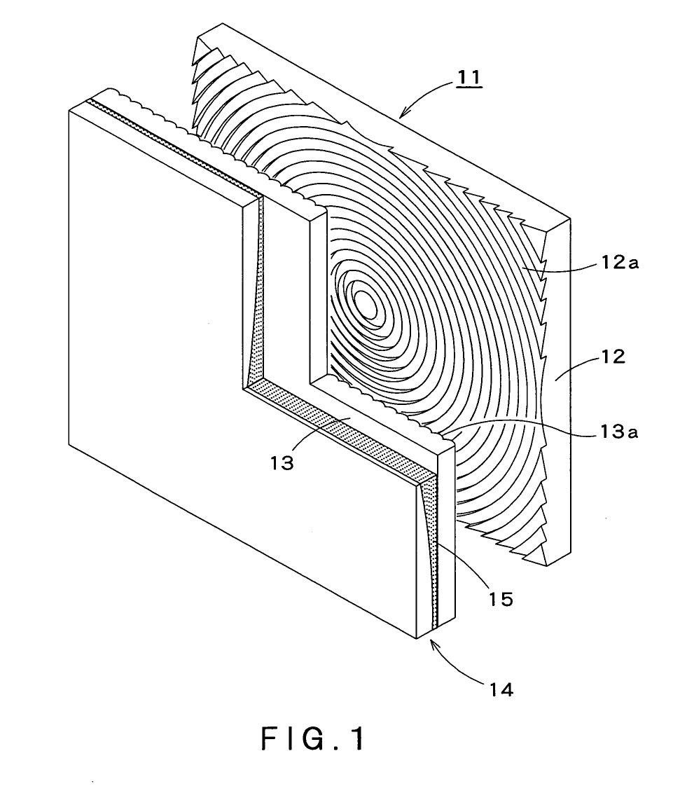

First of all, a rear projection screen according to an embodiment of the present invention will be described with reference to FIG. 1.

As shown in FIG. 1, a rear projection screen 11 according to this embodiment is a three-element screen comprising, as the two or more optical members for transmitting, diffusing, or condensing light, a Fresnel lens sheet 12, a lenticular lens sheet 13, and a resin base 14. These optical members 12, 13, 14 are in the form of sheets extending along the screen plane, and are arranged in the order mentioned, where the optical member 12 is the outermost one on the single-light-source projector side, a single-light-source projector (not shown in the figure) being placed on the far-side of the figure. The optical members 12, 13, 14 may take the form of either sheets with relatively high rigidity or windable films.

Of these optical members, the Fresnel lens sheet 12 is for transmitting, in the direction toward the viewer side, light from the light source while condensing it, and has a Fresnel lens 12a on the light-emerging surface side. The lenticular lens sheet 13 is for diffusing, in the horizontal direction, the light that is emerging from the Fresnel lens sheet 12, and has lenticular lenses 13a on the light-entering surface side. The lenticular lenses 13a are for diffusing light in the horizontal direction and constitute the outermost optical element on the viewer side.

The resin base 14 has a light-diffusing part (light-diffusing element) 15 on the light-entering surface side. The light-diffusing part 15 is situated on the viewer side of the lenticular lenses 13a on the lenticular lens sheet 13 that is the outermost optical element on the viewer side, and is so made that its light diffusivity in the vertical direction is higher at the center portion of the screen than at the upper and lower edge portions of the screen. The light-diffusing part 15 is a light-diffusing layer containing light-diffusing particles (for example a light-diffusing layer that diffuses light isotropically), and the thickness of this layer is small at the upper and lower edge portions of the screen and great at the center portion of the screen.

In the rear projection screen 11 shown in FIG. 1, the half angle of diffusion (the angle at which the luminance of emerging light is equal to a half of the maximum luminance) at the center portion of the screen is preferably from 1.04 to 1.90 times, more preferably from 1.08 to 1.75 times, the half angle of diffusion at the upper and/or lower edge portion of the screen.

In this respect, the inventor evaluated some rear projection screens with the diffusivity at the center portion of the screens varied. As a result, we found that an excellent scintillation-reducing effect can be obtained without lowering screen brightness as long as the half angle of diffusion at the center portion of the screen falls in the range of 1.04 to 1.90 times the angle of diffusion at the upper and/or lower edge portion of the screen, as described above. When the half angle of diffusion at the center portion of the screen is less than 1.04 times that at the upper and/or lower edge portion of the screen, a glaring-reducing effect is not observed. On the other hand, when the half angle of diffusion at the center portion of the screen is more than 1.90 times the angle of diffusion at the upper and/or lower edge portion of the screen, an excess gain reduction occurs in the center portion of the screen, and the image projected on the screen therefore appears dim.

Further, in the rear projection screen 11 shown in FIG. 1, it is preferable that the layer thickness, at the center portion of the screen, of the light-diffusing part 15 containing light-diffusing particles is preferably from 1.02 to 1.83 times, more preferably from 1.03 to 1.60 times, the layer thickness, at the upper and/or lower edge portion of the screen, of the light-diffusing part 15.

In this respect, the inventor evaluated some rear projection screens with the layer thickness of the light-diffusing part 15 varied at the center portion of the screen. As a result, the inventor found that an excellent scintillation-reducing effect can be obtained without lowering screen brightness as long as the layer thickness, at the center portion of the screen, of the light-diffusing part 15 falls in the range of 1.02 to 1.83 times the layer thickness, at the upper and/or lower edge portion of the screen, of the light-diffusing part 15, as described above. When the layer thickness, at the center portion of the screen, of the light-diffusing part 15 is less than 1.02 times the thickness, at the upper and/or lower edge portion of the screen, of the light-diffusing part 15, a glaring-reducing effect is not observed. On the other hand, when the layer thickness, at the center portion of the screen, of the light-diffusing part 15 is more than 1.83 times the layer thickness, at the upper and/or lower edge portion of the screen, of the light-diffusing part 15, an excess gain reduction occurs in the center portion of the screen, and the image projected on the screen therefore appears dim.

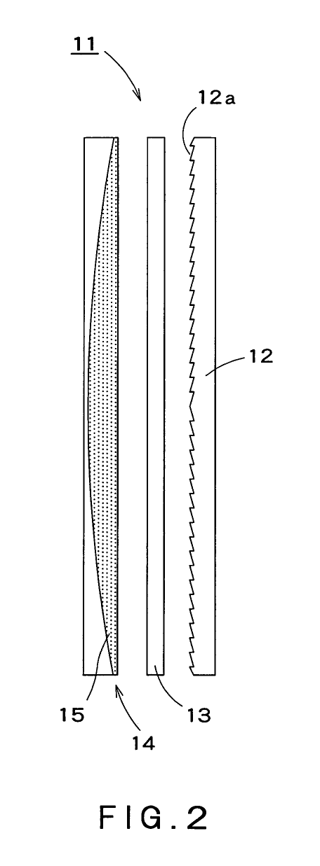

The lenticular lens sheet 13 and the resin base 14 in the rear projection screen 11 shown in FIGS. 1 and 2 are in close contact with each other or integrated with each other. Although the lenticular lens sheet 13 and the resin base 14 in the rear projection screen 11 shown in FIG. 2 are depicted as being in a separated state, this is only for convenience sake, and these optical members are actually used as being in close contact with each other or integrated with each other.

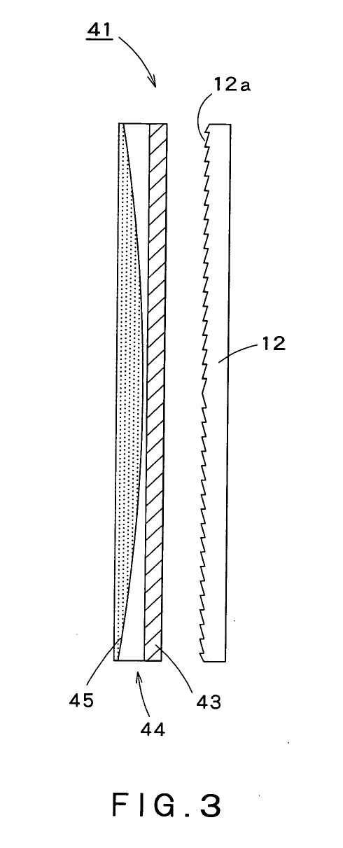

Further, although the lenticular lens sheet 13 and the resin base 14 in the rear projection screen 11 shown in FIG. 1 are discrete members, as in a rear projection screen 41 shown in FIG. 3, a film sheet 43 having a lenticular lens group (not shown in the figure) may be laminated to a resin base 44. In the rear projection screen 41 shown in FIG. 3, a light-diffusing part (light-diffusing element) 45 is provided on the light-emerging surface of the resin base 44. Like the above-described light-diffusing part 15, the light-diffusing part 45 is so made that the light diffusivity in the vertical direction of this part is higher at the center portion of the screen than at the upper and/or lower edge portion of the screen.

The rear projection screen 41 shown in FIG. 3 is almost the same as the rear projection screen 11 shown FIG. 1, except that the construction of the lenticular lens sheet and that of the resin base in the rear projection screen 41 are different from those in the rear projection screen 11. In FIGS. 1 and 3, like reference numerals designate like parts, and the detailed explanation of these parts, which has already been given in the description of the rear projection screen 11, will be omitted in the description of the rear projection screen 41.

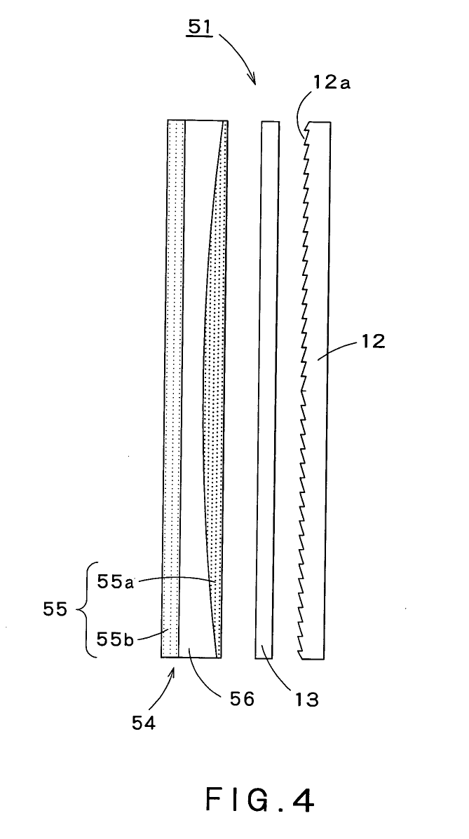

Although the resin base 14 of the rear projection screen 11 shown in FIG. 1 has, as the light-diffusing part 15, one light-diffusing layer containing light-diffusing particles, as shown in FIG. 4, the light-diffusing part 55 of the resin base 54 of a rear projection screen 51 may contain two or more light-diffusing layers containing light-diffusing particles (two light-diffusing layers 55a, 55b). In the rear projection screen 51 shown in FIG. 4, the light-diffusing layers 55a, 55b are provided on the both sides, the light-entering surface side and the light-emerging surface side, of the resin base 54, with a non-light-diffusing layer 56 containing no light-diffusing particles placed between the two light-diffusing layers 55a, 55b. Of these light-diffusing layers, at least one light-diffusing layer (the light-diffusing layer 55a on the light-entering surface side in FIG. 4) is so made that the thickness, at the upper and lower edge portions of the screen, of the layer is small and that the thickness, at the center portion of the screen, of the layer is great. Therefore, the light-diffusing layer 55a on the light-entering surface side shows light diffusivity in the vertical direction that is higher at the center portion of the screen than at the upper and lower edge portions of the screen. On the other hand, since the light-diffusing layer 55b on the light-emerging surface side has a uniform thickness, the light diffusivity in the vertical direction of this layer is uniform.

In the rear projection screen 51 shown in FIG. 4, the half angle of diffusion at the center portion of the screen is preferably from 1.04 to 1.90 times, more preferably from 1.08 to 1.75 times, the half angle of diffusion at the upper and/or lower edge portion of the screen, as in the rear projection screen 11 shown in FIG. 1. Further, the thickness, at the center of the screen, of the light-diffusing layer 55a of the light-diffusing part 55 is preferably from 1.02 to 1.83 times, more preferably from 1.03 to 1.60 times, the thickness, at the upper and/or lower edge portion of the screen, of the light-diffusing layers 55a, like the light-diffusing part 15 of the resin base 14 of the rear projection screen 11 shown in FIG. 1.

The rear projection screen 51 shown in FIG. 4 is almost the same as the rear projection screen 11 shown in FIG. 1, except that the construction of the resin base of the rear projection screen 51 is different from that of the resin base of the rear projection screen 11. In FIGS. 1 and 4, like reference numerals designate like parts, and the detailed explanation of these parts, which has already been given in the description of the rear projection screen 11, will be omitted in the description of the rear projection screen 51. Further, although the optical members 12, 13, 55 shown in FIG. 4 are depicted as being in a separated state, this is only for convenience sake, and these optical members may be in close contact with each other or integrated with each other.

The light-diffusing layers 55a, 55b of the light-diffusing part 55 of the resin base 54 of the rear projection screen 51 shown in FIG. 4 may be made to have the properties of diffusing light that are different from each other. In this case, diverse optical properties can be obtained because of the combined light-diffusing properties of the light-diffusing layers 55a, 55b, as compared with the case where only one light-diffusing layer (light-diffusing part 15) is used as in the rear projection screen 11 shown in FIG. 1.

Specifically, for example, in the case where a light-diffusing agent (light-diffusing particles) whose refractive index differs only slightly from the refractive index of the base material and a light-diffusing agent (light-diffusing particles) whose refractive index greatly differs from the refractive index of the base material are incorporated in the light-diffusing layers 55a, 55b, if the former light-diffusing agent is incorporated in the light-diffusing layer 55a situated on the light-entering surface side, and the latter light-diffusing agent, in the light-diffusing layer 55b situated on the light-emerging surface side, it is possible to obtain resolution that is higher than the resolution obtained when a mixture of the above two different light-diffusing agents is incorporated in one light-diffusing layer. Moreover, since the non-light-diffusing layer 56 that contains no light-diffusing particles is provided between the light-diffusing layers 55a, 55b, glaring that occurs on the screen is reduced.

In the above case, if at least one light-diffusing layer (here the light-diffusing layer 55a) of the two or more light-diffusing layers (here the light-diffusing layers 55a, 55b) is made to have such a layer thickness distribution that the thickness, at the upper and/or lower edge portion of the screen, of the light-diffusing layer is small and that the thickness, at the center portion of the screen, of the light-diffusing layer is great, in order to make the light diffusivity in the vertical direction of the light-diffusing layer higher at the center portion of the screen than at the upper and/or lower edge portion of the screen, reductions in glaring that occurs in the center portion of the screen on which the highest illuminance is observed can be attained.

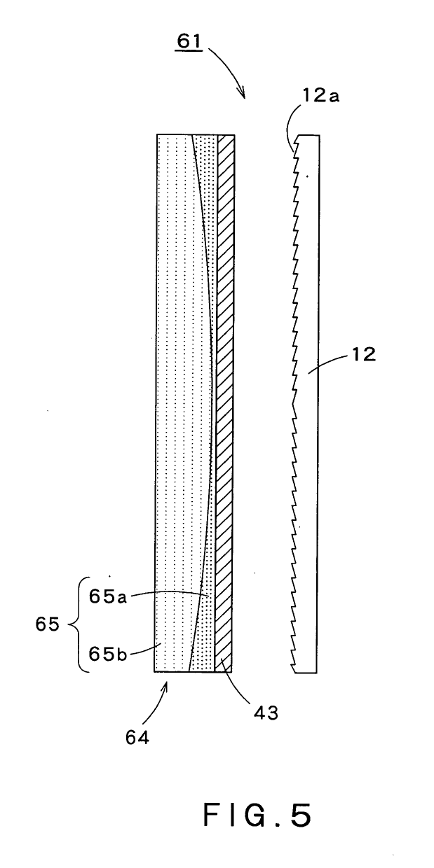

In this case, it is possible to freely set the thickness of the other light-diffusing layer. The other light-diffusing layer (light-diffusing layer 55b) may be made to have a uniform thickness as in the rear projection screen 51 shown in FIG. 4. Alternatively, as in a rear projection screen 61 shown in FIG. 5, the other light-diffusing layer (light-diffusing layer 65a) may be made so that the thickness of the layer at its upper and lower edge portions is different from that of the layer at its center portion.

Specifically, in the rear projection screen 61 shown in FIG. 5, a film sheet 43 having a lenticular lens group (not shown in the figure) is laminated to a resin base 64. The light-diffusing part 65 of the resin base 64 is composed of two light-diffusing layers 65a, 65b containing two different types of light-diffusing particles, the difference between the refractive index of the light-diffusing particles incorporated in the light-diffusing layer 65a and that of the base material of the light-diffusing layer 65a being different from the difference between the refractive index of the light-diffusing particles incorporated in the light-diffusing layer 65b and that of the base material of the light-diffusing layer 65b. The light-diffusing layer 65b on the light-emerging surface side contains light-diffusing particles whose refractive index differs only slightly from the refractive index of the base material, while the light-diffusing layer 65a on the light-entering surface side contains light-diffusing particles whose refractive index greatly differs from the refractive index of the base material. Further, the thickness of the light-diffusing layer 65b on the light-emerging surface side is great at the center portion of the screen and small at the upper and lower edge portions of the screen. On the other hand, the thickness of the light-diffusing layer 65a on the light-entering surface side is small at the center portion of the screen and great at the upper and lower edge portions of the screen.

When the light-diffusing layer 65b situated on the light-emerging surface side, containing light-diffusing particles whose refractive index differs only slightly from the refractive index of the base material, is made to have such a layer thickness distribution that the thickness, at the center portion of the screen, of the light-diffusing layer is greater than the thickness, at the upper and lower edge portions of the screen, of the light-diffusing layer, the light diffusivity at the center portion of the screen becomes high due to such a layer thickness distribution, and a bright image with no imaging light voids can be obtained. However, in such a light-diffusing layer 65b situated on the light-emerging surface side, since the difference between the refractive index of the light-diffusing particles and that of the base material is small, the upper and lower edge portions of the light-diffusing layer 65b, the layer thickness of these parts being small, only slightly contribute to the diffusion of light at wide angles. Therefore, the lower part of the screen may not appear sufficiently bright when the screen is viewed from above.

On the other hand, the light-diffusing particles whose refractive index is greatly different from the refractive index of the base material greatly contribute to the diffusion of light at wide angles, and only slightly contribute to the diffusion of light at narrow angles. For this reason, when the light-diffusing layer 65a to be situated on the light-entering surface side, containing light-diffusing particles whose refractive index is greatly different from the refractive index of the base material, is made to have such a layer thickness distribution that the thickness, at the center portion of the screen, of the light-diffusing layer is smaller than the thickness, at the upper and lower edge portions of the screen, of the light-diffusing layer, and is combined with the above-described light-diffusing layer 65b to be situated on the light-emerging surface side, the dimness on the lower part of the screen that is observed when the screen is viewed from above can be improved without unnecessarily enhancing the diffusivity at the center of the screen. Consequently, the image viewed from the front is void-free and is bright at the upper and lower edge portions of the screen, and there can be obtained a luminance distribution that makes the lower part of the screen appear bright even when the screen is viewed from above.

In the rear projection screens 11, 41, 51, 61 shown in FIGS. 1 to 5, resin materials such as acrylic resins, acryl-styrene copolymer resins (MS), styrene resins, polycarbonate, and polyethylene are usually used to form the optical members such as the Fresnel lens sheet 12, the lenticular lens sheets 13, 43, and the resin bases 14, 44, 54, 64. Such a technique as extrusion, casting, or press molding may be used to form these optical members. Alternatively, there may be used, as the base, a film of polyethylene terephthalate (PET), polybutylene terephthalate (PBT), or the like, and, for shaping, an electron beam curing resin. When the Fresnel lens sheet 12 and the lenticular lens sheets 13, 43 are in the form of films, substrates are needed to support these sheets. Although the resin bases 44, 64 of the rear projection screens 41, 61 shown in FIGS. 3 and 5, respectively, serve as the substrates, glass plates or the like may be provided separately. Please note that the same substrates may be provided in the Fresnel lens sheet 12, although it is not depicted in FIGS. 3 and 5.

Further, in the rear projection screens 11, 41, 51, 61 shown in FIGS. 1 to 5, the light-diffusing part 15, 45, 55 or 65 that is a light-diffusing layer containing light-diffusing particles is formed as a part of the resin base 14, 44, 54 or 64, as mentioned above. Alternatively, the light-diffusing part may be provided by forming, by such a technique as coating or lamination, a light-diffusing-particles-containing layer on the surface of the lenticular lens sheet 13 or 43, or of the other lens sheet. Further, when the lens sheet body or the sheet for supporting the lens film, which constitutes the lenticular lens sheet 13 or 43, or the other lens sheet, is made to have a multiple layer structure by using such a technique as extrusion, a light-diffusing part can be created by incorporating light-diffusing particles in at least one of the multiple layers. When not a layer containing light-diffusing particles but such an embossed surface as will be described later is used for making the light-diffusing part 15, 45, 55 or 65, the light-emerging surface of the lens sheet or the like may be matted. In the case where a laminate of multiple sheets is used, it is possible to impart the diffusing properties to the laminate by matting the joint surfaces, or by properly selecting materials for the sheets so that a difference in refractive index is produced at the sheet-sheet interface.

The above-described technique such as coating, lamination, or multilayer molding may also be used to form an optional component (e.g., a screen protective plate) that is placed on the viewer side of the lenticular lens sheet 13 or 43, or of the other lens sheet. The technique that can be used to form such an optional component is not limited to the above-described ones.

In the formation of the light-diffusing layer on the surface of the lens sheet or the like by the above-described technique of coating, if the coating is to cover the surface of the outermost component on the viewer side (the outermost surface on the viewer side), it is preferable to use a binder having scratch resistance in which light-diffusing particles are dispersed. By using such a binder to form the light-diffusing layer, it is possible to prevent the surface of the rear projection screen from being scratched.

Crosslinking beads made from acrylic resin, styrene resin, an acryl-styrene copolymer, or the like are usually used as the light-diffusing particles that are incorporated in the light-diffusing part 15, 45, 55 or 65. Beads made from an inorganic material such as silica or alumina may be used as well. Although the particle diameter of such light-diffusing particles is usually about 2 to 30 μm, it may be selected purposively, and a mixture of two or more different types of light-diffusing particles may also be used.

### Other Embodiments

In the above-described embodiment, the rear projection screens 11, 41, 51, 61 have been described with reference to the case where the light diffusivity in the vertical direction is higher at the center portion of the screen than at both the upper and the lower edge portions of the screen. However, even in the case where the light diffusivity in the vertical direction is higher at the center portion of the screen than at either the upper or lower edge portion of the screen, the actions and effects of the present invention can be obtained to a certain extent, and it is a matter of course that this case is also included in the scope of the present invention.

Further, the above embodiment has been described with reference to the case where the lenticular lenses 13a on the lenticular lens sheet 13 (or the film sheet 43 having a lenticular lens group (not shown in the figure)), which is the viewer-side outermost optical element of the rear projection screen 11, 31, 41, 51 or 61, are for diffusing light in the horizontal direction. The present invention is not limited to this case, and the lenticular lenses extending in the horizontal direction may be used for diffusing light in the vertical direction, or a fry eye lens or the like may be used for diffusing light in both the horizontal and the vertical directions.

Furthermore, the above embodiment has been described with reference to the case where the lenticular lenses 13a on the lenticular lens sheet 13 (or the film sheet 43 having a lenticular lens group (not shown in the figure)) constitute the viewer-side outermost optical element of the rear projection screen 11, 41, 51 or 61. The present invention is not limited to this case, and light-diffusing prisms capable of diffusing light in the horizontal and/or vertical direction may be used instead of the lenticular lenses 13a.

Furthermore, the above embodiment has been described with reference to the case where the light-diffusing part 15, 45, 55 or 65 of the resin base 14, 44, 54 or 64 is composed of a light-diffusing layer containing light-diffusing particles. The present invention is not limited to this case, and the light-diffusing part may be provided by embossing the surface of the resin base 14, or by the combination use of the light-diffusing layer and an embossed surface.

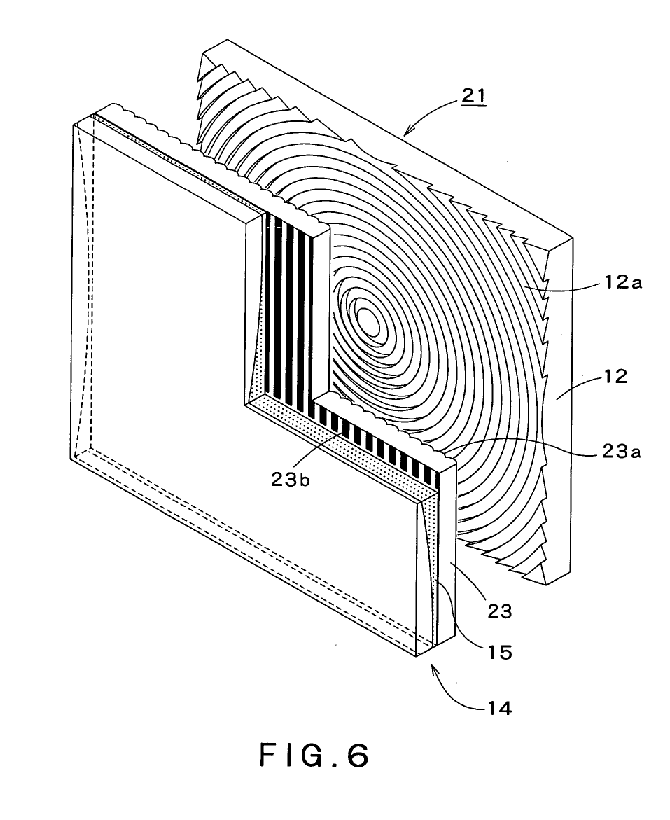

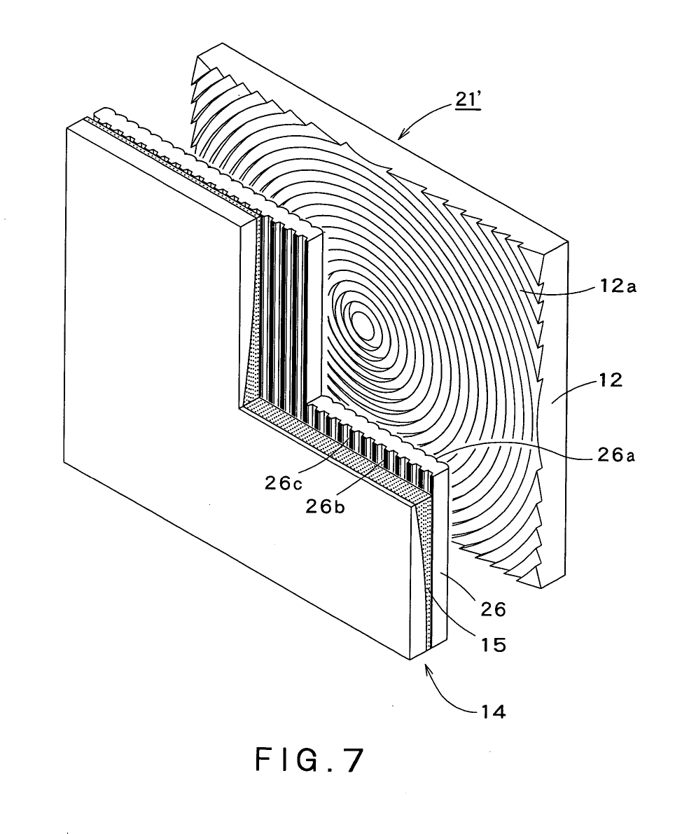

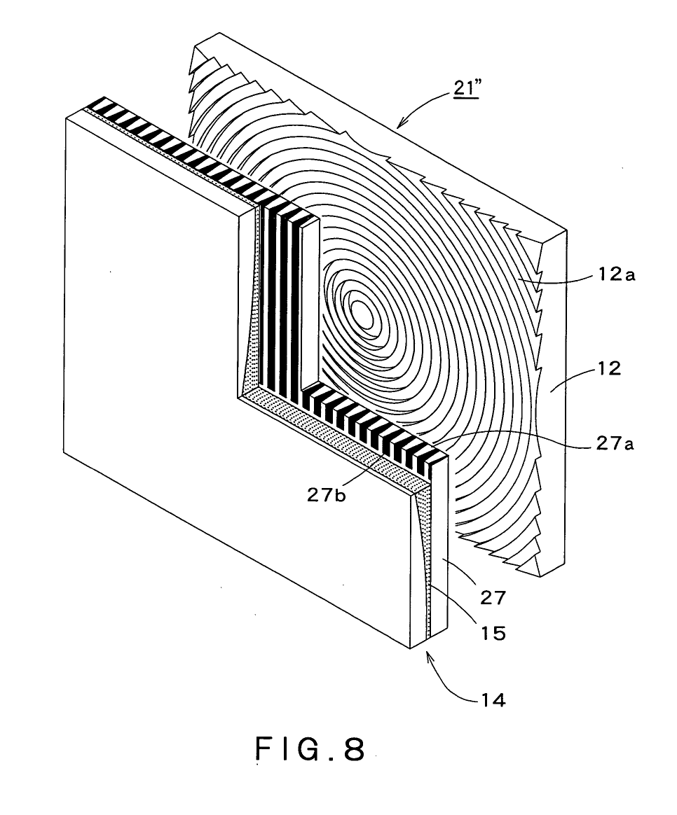

Furthermore, although a lenticular lens sheet that has no light-absorbing part (light-absorbing element) is used as the lenticular lens sheet 13 or 43 in the above-described embodiment, as in a rear projection screen 21, 21′ or 21″ shown in FIG. 6, 7 or 8, a lenticular lens sheet 23, 26 or 27 having light-absorbing parts (light-absorbing elements) 23b, 26b or 27b on the light-emerging surface side may also be used. The lenticular lens sheet 23 shown in FIG. 6 is a single lenticular lens sheet having lenticular lenses 23a on the light-entering surface side, and, on the light-emerging surface side, light-absorbing parts 23b in no-light-emerging areas through which no light passes. The lenticular lens sheet 26 shown in FIG. 7 is a double lenticular lens sheet having lenticular lenses 26a, 26c on both the light-entering and light-emerging surface sides, and further, on the light-emerging surface side, light-absorbing parts 26b in no-light-emerging areas through which no light passes. The lenticular lens sheet 27 shown in FIG. 8 is a total-reflection-type lenticular lens sheet that has total-reflection trapezoidal prisms 27a and light-absorbing parts 27b provided between the trapezoidal prisms 27a.

In the rear projection screen 21, 21′ or 21″ shown in FIG. 6, 7 or 8, the light-diffusing part (light-diffusing element) 15 of the resin base 14 is situated on the viewer side of the light-absorbing parts 23b, 26b or 27b, light-absorbing elements for absorbing light, of the lenticular lens sheet 23, 26 or 27, and is made so that its light diffusivity in the vertical direction is higher at the center portion of the screen than at the upper and/or lower edge portion of the screen. It is therefore not necessary to concern about the reduction in luminance due to loss of imaging light at the light-absorbing parts 23b, 26b or 27b that is caused by the increase in the degree to which imaging light is diffused, and it becomes possible to obtain a rear projection screen that scarcely causes glaring.

### EXAMPLES

### Example 1

A 2-mm thick resin base having, on its light-emerging surface, a light-diffusing layer, and, on its light-entering surface, an acrylic resin layer (refractive index 1.49) that had been colored by a transparent pigment was prepared. The light-diffusing layer provided on the light-emerging surface side was as follows: an acrylic resin (refractive index 1.49) that had been colored by a transparent pigment was used as a base material; in this acrylic resin were incorporated spherical beads (3.8% by weight) made from a crosslinking acryl-styrene copolymer resin, having a mean particle diameter of 12 μm and a refractive index of 1.51, and spherical beads (3.0% by weight) made from a crosslinking acryl-styrene copolymer resin, having a mean particle diameter of 9 μm and a refractive index of 1.56. The light-diffusing layer was so formed that the thickness, at the center portion of the screen, of the layer was 1.13 times the thickness, at the upper and lower edge portions of the screen, of the layer.

A sheet in the form of a film, having, on the light-entering surface side, a group of lenticular lenses extending in the vertical direction was laminated to the above-prepared resin base, thereby obtaining a lens sheet. This lens sheet was combined with a Fresnel lens sheet that was designed so that light rays from an image projection tube would emerge from the lens sheet almost in parallel. There was thus obtained a rear projection screen of Example 1.

The image projected on the rear projection screen of Example 1 was evaluated. It was found that the image was reduced in glaring and was excellent in resolution.

### Example 2

A 2-mm thick resin base having, on its light-emerging surface, a light-diffusing layer, and, on its light-entering surface, an acryl-styrene copolymer resin layer (refractive index 1.53) that had been colored by a transparent pigment was prepared. The light-diffusing layer provided on the light-emerging surface side was as follows: an acryl-styrene copolymer resin (refractive index 1.53) that had been colored by a transparent pigment was used as a base material; in this copolymer resin were incorporated crosslinking styrene spherical beads (3.0% by weight) having a mean particle diameter of 10 μm and a refractive index of 1.55, and crosslinking styrene spherical beads (3.3% by weight) having a mean particle diameter of 9 μm and a refractive index of 1.60. The half angle of diffusion at the center portion of the light-diffusing layer was made 1.25 times that at the upper and lower edge portions of the light-diffusing layer.

On the other hand, an ultraviolet-light-reactive adhesive layer was formed on the light-emerging surface of a film sheet having, on the light-entering surface side, a group of lenticular lenses extending in the vertical direction, and ultraviolet parallel light was applied to the film sheet from the light-entering surface side. A black-colored transfer sheet was laminated to the light-emerging surface, on which those parts, in the shape of stripes, of the adhesive layer that had been exposed to the ultraviolet light had no tackiness, thereby obtaining a lens film having black-colored light-absorbing parts on the adhesive parts (non-light-emerging parts). This lens film was laminated to the above-prepared resin base, and the thus obtained lens sheet was combined with a Fresnel lens sheet that was designed so that light rays from an image projection tube would emerge from the lens sheet almost in parallel, thereby obtaining a rear projection screen of Example 2.

The image projected on the rear projection screen of Example 2 was evaluated. It was found that the image was reduced in glaring and was excellent in both resolution and contrast.

### COMPARATIVE EXAMPLE

A 2-mm thick resin base having, on its light-emerging surface, a light-diffusing layer, and, on its light-entering surface, an acrylic resin layer (refractive index 1.49) that had been colored by a transparent pigment was prepared. The light-diffusing layer provided on the light-emerging surface side was as follows: an acrylic resin (refractive index 1.49) that had been colored by a transparent pigment was used as a base material; in this acrylic resin were incorporated spherical beads (3.8% by weight) made from a crosslinking acryl-styrene copolymer resin, having a mean particle diameter of 12 μm and a refractive index of 1.51, and spherical beads (3.0% by weight) made from a crosslinking acryl-styrene copolymer resin, having a mean particle diameter of 9 μm and a refractive index of 1.56. The light-diffusing layer was formed so that it had a uniform thickness.

A sheet in the form of a film, having, on the light-entering surface side, a group of lenticular lenses extending in the vertical direction was laminated to the above-prepared resin base, thereby obtaining a lens sheet. This lens sheet was combined with a Fresnel lens sheet that was designed so that light rays from an image projection tube would emerge from the lens sheet almost in parallel. There was thus obtained a rear projection screen of Comparative Example.

The image projected on the rear projection screen of Comparative Example was found to be undergoing glaring.

What is claimed is:

1. A rear projection screen comprising:
two or more optical members for transmitting, diffusing, or condensing light, in a form of sheets or windable films extending along a screen plane,
the two or more optical members including one, or two or more optical elements that comprise lenses or prisms for diffusing light in a horizontal and/or vertical direction, and a light-diffusing element that is situated on a viewer side of a viewer-side outermost optical element of the one, or two or more optical elements,
a light diffusivity in the vertical direction of the light-diffusing element being higher at a center portion of the screen than at an upper and/or lower edge portion of the screen.

2. The rear projection screen according to claim 1, wherein a half angle of diffusion at the center portion of the screen is 1.04 to 1.90 times that at the upper and/or lower edge portion of the screen.

3. The rear projection screen according to claim 1, wherein the light-diffusing element comprises a light-diffusing layer that contains light-diffusing particles.

4. The rear projection screen according to claim 3, wherein a thickness of the light-diffusing layer is small at the upper and/or lower edge portion of the screen and great at the center portion of the screen.

5. The rear projection screen according to claim 4, wherein the thickness, at the center portion of the screen, of the light-diffusing layer is 1.02 to 1.83 times the thickness, at the upper and/or lower edge portion of the screen, of the light-diffusing layer.

6. The rear projection screen according to claim 1, wherein the light-diffusing element comprises two or more light-diffusing layers containing light-diffusing particles, and a thickness of at least one of the two or more light-diffusing layers is small at the upper and/or lower edge portion of the screen and great at the center portion of the screen.

7. The rear projection screen according to claim 6, wherein the thickness of at least one, at the center portion of the screen, of the two or more light-diffusing layers is 1.02 to 1.83 times the thickness, at the upper and/or lower edge portion of the screen, of the at least one light-diffusing layer.

8. The rear projection screen according to claim 6, wherein the two or more light-diffusing layers have properties of diffusing light that are different from each other.

9. The rear projection screen according to claim 6, wherein the light-diffusing element contains a non-light-diffusing layer provided between the two or more light-diffusing layers.

10. A rear projection screen comprising:
two or more optical members for transmitting, diffusing, or condensing light, in a form of sheets or windable films extending along a screen plane,
the two or more optical members including a light-absorbing element for absorbing light and a light-diffusing element that is situated on a viewer side of the light-absorbing element,
a diffusivity in a vertical direction of the light-diffusing element being higher at a center portion of the screen than at an upper and/or lower edge portion of the screen.

11. The rear projection screen according to claim 10, wherein a half angle of diffusion at a center portion of the screen is 1.04 to 1.90 times that at the upper and/or lower edge portion of the screen.

12. The rear projection screen according to claim 10, wherein the light-diffusing element comprises a light-diffusing layer that contains light-diffusing particles.

13. The rear projection screen according to claim 12, wherein a thickness of the light-diffusing layer is small at the upper and/or lower edge portion of the screen and great at the center portion of the screen.

14. The rear projection screen according to claim 13, wherein the thickness, at the center portion of the screen, of the light-diffusing layer is 1.02 to 1.83 times the thickness, at the upper and/or lower edge portion of the screen, of the light-diffusing layer.

15. The rear projection screen according to claim 10, wherein the light-diffusing element comprises two or more light-diffusing layers containing light-diffusing particles, and a thickness of at least one of the two or more light-diffusing layers is small at the upper and/or lower edge portion of the screen and great at the center portion of the screen.

16. The rear projection screen according to claim 15, wherein the thickness of at least one, at the center portion of the screen, of the two or more light-diffusing layers is 1.02 to 1.83 times the total thickness, at the upper and/or lower edge portion of the screen, of the at least one light-diffusing layer.

17. The rear projection screen according to claim 15, wherein the two or more light-diffusing layers have properties of diffusing light that are different from each other.

18. The rear projection screen according to claim 15, wherein the light-diffusing element contains a non-light-diffusing layer provided between the two or more light-diffusing layers.
